(19) United States
(12) Patent Application Publication
(10) Pub. No.: US 2012/0068613 A1
(43) Pub. Date: Mar. 22, 2012

(54) MOTION DETECTOR NIGHT LIGHT FOR TOILET BOWL

(76) Inventor: Dominic M. Veneto, Norwell, MA (US)

(21) Appl. No.: 13/233,687

(22) Filed: Sep. 15, 2011

Related U.S. Application Data
(60) Provisional application No. 61/383,179, filed on Sep. 15, 2010.

(51) Int. Cl. F21V 33/00; H05B 37/02

(52) U.S. Cl. 315/159; 362/101

(57) ABSTRACT

A light assembly for a toilet, that is movement responsive, so that when a person enters the bathroom, and walks near the toilet, a motion detector will sense their presence, and activate lights. The light may be one or more LED's contained in a water resistant enclosure, such as a plastic material, and placed inside the upper rim of the toilet bowl.

### RELATED APPLICATIONS

This application claims priority to U.S. Provisional Patent Application Ser. No. 61/383,179, filed Sep. 15, 2010, which is incorporated herein by reference in its entirety.

### FIELD OF THE INVENTION

The current disclosure is directed to a light for a toilet bowl, wherein the light is responsive to motion, such that when someone or something enters the field of view of a sensor element, the light is turned on within the toilet bowl.

### BACKGROUND

Various attempts have been made to illuminate a toilet at night for male users. The noted prior art attempts include the following patents:

U.S. Pat. No. 5,664,867 of Martin describes a night light for a toilet that turns on when the toilet seat is lifted up.

U.S. Pat. No. 4,736,471, of Johnson describes a toilet including a toilet bowl, a seat, a central opening, and a lid. The lid and the seat are hinged to the bowl and have a lowered position overlying the bowl and a raised substantially upright position. A light assembly is mounted on the underside of the lid in a position framed by the seat opening with the seat and lid in an upright position. The light assembly is operated by a gravity switch wherein the light is on when the seat is in the upright position and off in the lowered position.

U.S. Pat. No. 4,413,364, of Bittaker describes a housing having a means thereon for mounting it on top of a toilet bowl at the back. Bittaker also discloses a lamp socket mounted on the housing that extends down in front of the rear inner edge of the toilet bowl. Furthermore, the housing of Bittaker has a depending front end segment extending down in front and on opposite sides of the socket. The housing also has a bottom wall with an opening therein. The socket has an electrical terminal at its upper end which projects up through the opening.

In general, the prior art describes toilet seat lights which are placed in the upright position in order to activate the light source. Other prior art patents also have the disadvantage of being activated by flushing, which requires auxiliary fluid mechanical components.

### OBJECTS OF THE INVENTION

It is an object of the invention is to provide a toilet light which is adaptable to a variety of different toilets to provide illumination when motion or movement is detected.

Another object is to provide a toilet light which is motion activated.

Another object is to provide a self-contained battery-powered light unit.

Another object is to provide a light unit which is mounted in an area that is least subject to unsanitary contamination.

It is yet another object of the invention to provide a toilet light which avoids contact with the unsanitary toilet bowl rim.

Another object is to provide a light unit and accessories which are inexpensive to manufacture.

Another object is to provide a toilet light unit which is reliable, easy to service, and requires no tools for installation.

It is yet another object to provide a light unit for a toilet having a body of a simple, relatively flexible structural configuration, which fits close to the plane of the underside of a toilet bowl rim, wherein the configuration of the light emitting end maximizes light distribution while protecting the LED light from external damage.

It is another object of the invention to provide an illuminated night light for a toilet, wherein the light is movement responsive, so that when someone or something enters the field of vision of the motion detector, the light turns on.

It is yet another object of the invention to provide a toilet light which maximizes the illuminated area of a toilet.

It is yet another object of the invention to create a light source only at night, when needed.

It is yet another object of the invention to create a more “green” environment by the use of battery power to power a low power light source, saving use of electric power for higher power room lights.

It is yet another object to improve over the disadvantages of the prior art.

Some or all of the foregoing objects may be achieved in accordance with embodiments of the invention. Though, it should be appreciated that not every embodiment need achieve every object, and that other objects and advantages may be achieved by embodiments of the invention.

### SUMMARY

In accordance with some embodiments, a night light for use with a toilet is activated by motion or movement within the field of vision of a motion detector attached to the front edge of a toilet bowl rim. In some embodiments, the night light is held in place by a water resistant bracket, strap, hinged connection, or other appropriate method of attaching the night light to the toilet. In one embodiment the light source is contained within a flexible plastic tubing that fits underneath the upper edge of the toilet bowl rim. In one embodiment, the light source may comprise at least one or more LEDs. However, any appropriate light source could be used. In some embodiments, the night light remains lit while the motion detector senses the presence of someone or something within its field of vision. In another possible embodiment, the night light shuts off after a predetermined amount of time and/or after the sensed presence has left the field of vision of the motion sensor.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 shows a toilet with the electronics and battery enclosure visible on the outer surface of the toilet in accordance with some illustrative embodiments of the invention;

FIG. 2 shows a front view of a night light in accordance with some illustrative embodiments of the invention;

FIG. 3 shows a top view of a night light of FIG. 2 mounted to a toilet bowl;

FIG. 4 shows a schematic of a lighting circuit that may be incorporated in a night light in accordance with some illustrative embodiments of the invention; and

FIG. 5 shows a schematic of an exemplary embodiment of a night light circuit.

### DETAILED DESCRIPTION

Applicants have recognized and appreciated a disadvantage of known prior art toilet lights is that the lights are activated only when the toilet seat is lifted, and remains in the up position. The prior art does not account for lighting of the toilet while the seat is in the down position, or for providing illumination inside of the toilet bowl. Furthermore, the prior art results in the light remaining lit as long as the toilet seat remains in the upright position.

Moreover, none of the prior art devices include a light source which can be activated by motion or movement, even if the toilet seat is in the lowered position.

In addition, none of the prior art devices describe a light body of a simple structural configuration which fits close to the plane of the underside of a toilet seat, as opposed to a toilet seat cover, wherein the configuration of the light emitting end maximizes light distribution.

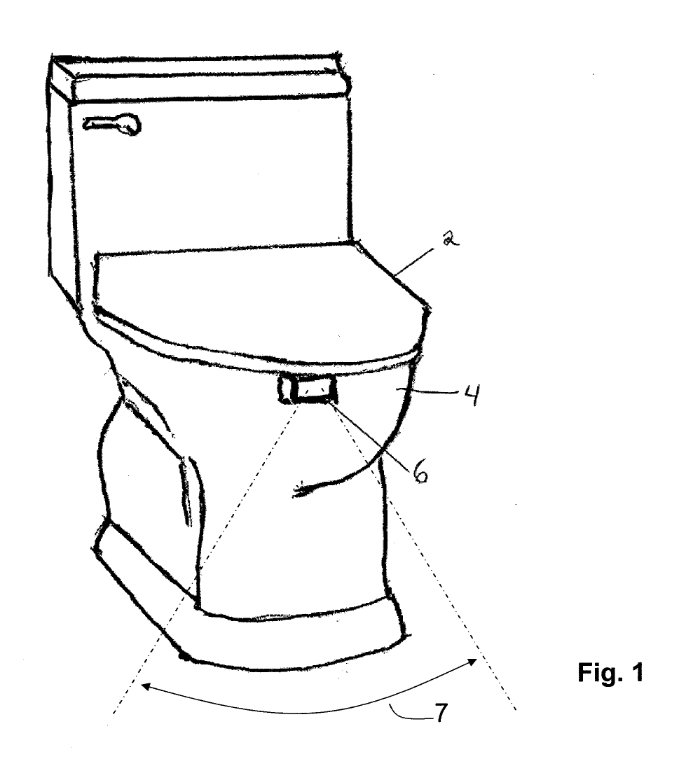

FIG. 1 shows a toilet 2 with a toilet bowl 4. The electronics and battery enclosure 6 of a night light assembly is visible on the exterior surface of the toilet.

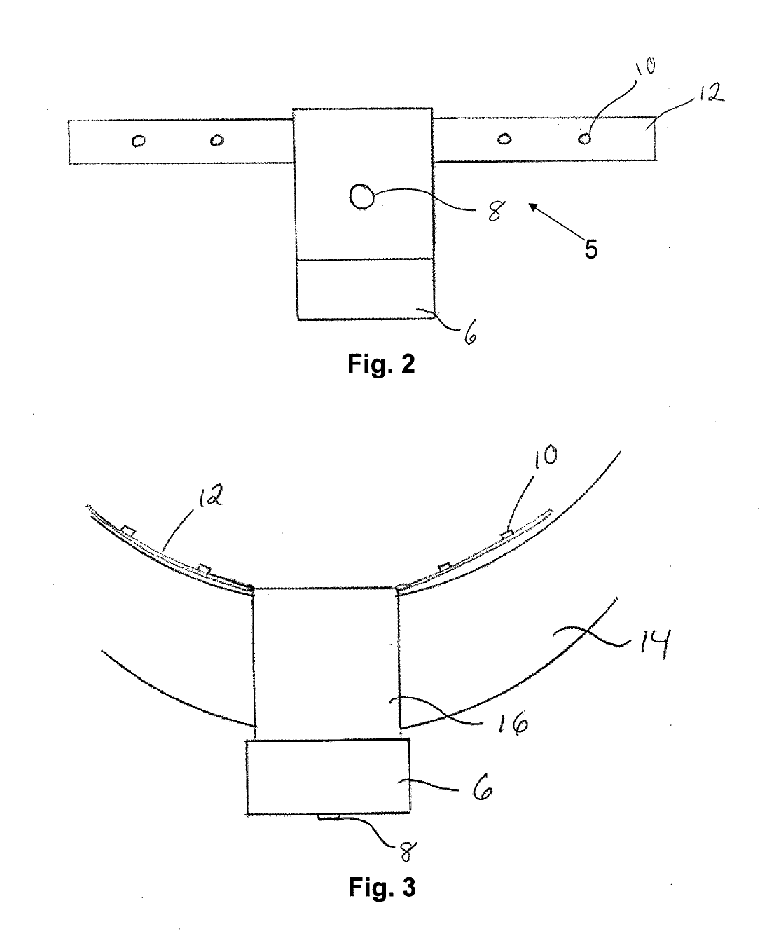

FIG. 2 shows a front view of night light assembly 5. In the embodiment illustrated, night light assembly 5 includes a battery enclosure 6, a motion detector 8, lights 10, and flexible tubing 12. These elements are held together in any suitable way to form an assembly. In some embodiments, these components may be attached to a support member. The support member may be a unitary component or may, in some embodiments, include multiple components that are affixed to each other. There is no requirement that all of the components be rigidly coupled together. For example, the lights 10 may be mounted to separate support member than battery enclosure 6 and motion detector 8. Nonetheless, these components may be operatively coupled using a wire or other non-rigid mechanism.

In some embodiments, these components may be commercially available components or commercially available components attached to support members that provide the desired shape. For example, the motion detector may be a passive infrared detector (PIR) of a type as is known in the art. Motion detector 8 may be sensitive to changes in radiation from within a field of view 7. In the embodiment illustrated, a person within the field of view may emit infrared radiation of sufficient magnitude to trigger motion detector 8 to provide an output. Appropriate threshold conditions for triggering motion detector 8 may be established. For example, motion detector 8 may be configured to provide an output only when movement of a source of radiation above threshold speed or threshold amount is detected.

Flexible tubing 12 encloses lights 10 and protects them from the water present inside toilet bowl 4. Tubing 12 may be of a clear, though flexible material such as vinyl or other plastic. In some embodiments, the lights may be sealed within the tube, or other member that acts as a water resistant housing, with a seal that excludes water. Lights 10 may be at least one light source and may in some embodiments be multiple light emitting diodes (LEDs). In the embodiment illustrated, the lights 10 are four white LEDs.

Battery enclosure 6 may be molded from plastic or other suitable material to contain one or more batteries. Wires or other electrical coupling may supply power from batteries within battery enclosure 6 to lights 10, motion detector 8 and/or a control circuit. Battery enclosure 6 may also serve to enclose the control circuit and may also act as a support to which motion detector 8 may be attached. In some embodiments, battery enclosure 6 may include a gasket or other sealing member to act as a seal to prevent water or other fluids from entering the enclosure. A water resistant coupling may be provided between the batteries and/or control circuit within battery enclosure 6 and lights 10 and/or motion detector 8. In some embodiments, a water resistant coupling may be provided by gaskets or other sealing members between separate members. Though, other suitable implementations may be used, including encapsulating the components to be coupled in a water resistant material, such as silicone or plastic.

Battery enclosure 6 may have a shape as illustrated in FIGS. 2 and 3 or other shape, either alone or in combination with other members in the assembly, that is configured for attachment to a front of a toilet bowl 4. FIG. 3 shows a top view of night light assembly 5 mounted on a toilet bowl rim 14.

Night light assembly 5 may be attached to toilet bowl rim 14 by a water resistant connector. Such a water resistant connection may be formed in any number of ways including but not limited to a water resistant: bracket; hinged connection; straps; adhesives; hook and loop fasteners (i.e. Velcro®); or any other appropriate means. In the embodiment illustrated, when night light assembly 5 is mounted to toilet bowl rim 14, enclosure 6 and motion detector 8 are located on the toilet bowl exterior while lights 10 and flexible tubing 12 are located on the toilet bowl interior. As shown, tubing 12 may either conform to the shape of the toilet bowl interior or may be sufficiently flexible such that it can conform to the desired shape when night light assembly 5 is attached to the toilet bowl.

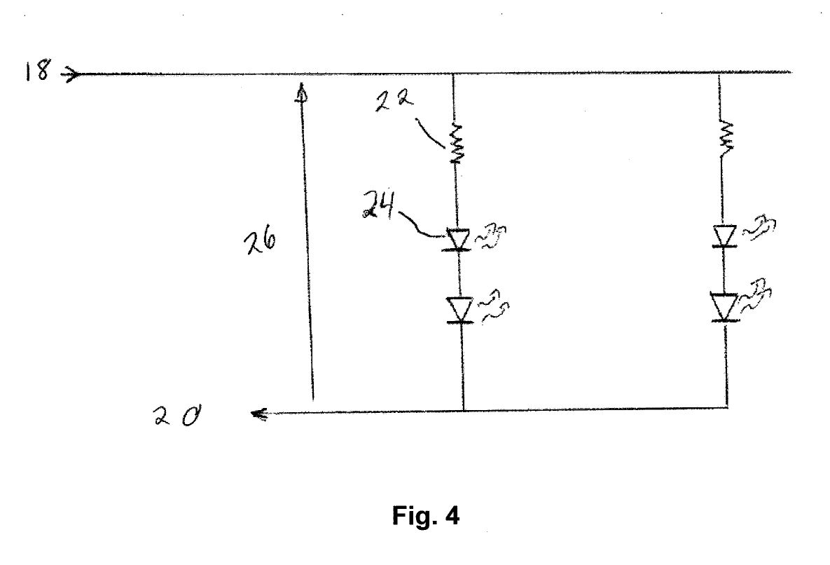

FIG. 4 shows one embodiment of the lighting circuit that may be enclosed within flexible tube 12 or otherwise incorporated into night light assembly 5. The circuit includes an input 18 from the power supply, a connection 20 to a normally open contact NO, resistors 22 and LEDs 24. A common collector voltage 26, derived from batteries in battery enclosure 6 or other suitable power source, may be applied between input 18 and connection 20 when the normally open contact is closed by operation of the control circuit.

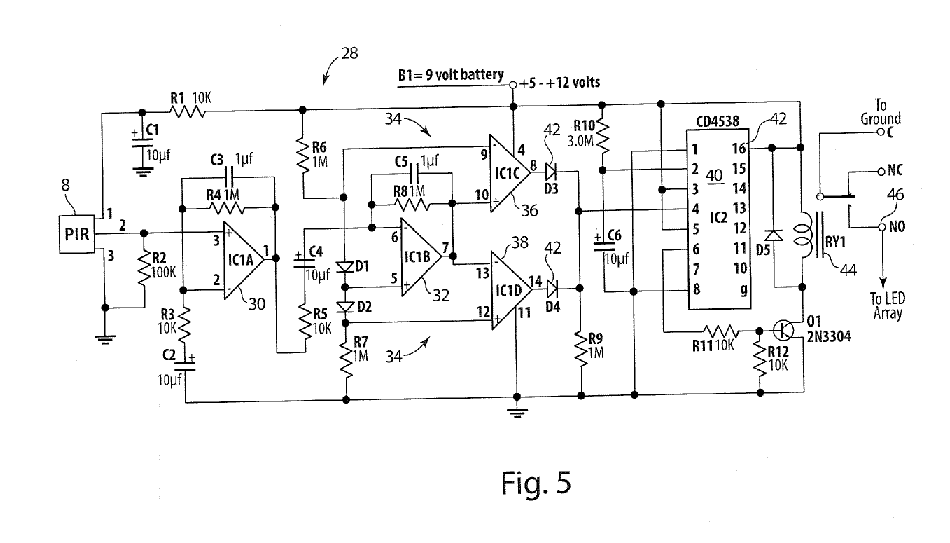

FIG. 5 depicts an embodiment of the control circuitry 28. The high impedance output of the motion detector 8, producing a low level voltage change, upon detecting changes in IR, is buffered by amplifier IC1A 30. This is AC coupled to IC1B 32 and subsequently amplified. The output signal is then passed through two further gain stages 34 to produce digital pulses for both positive and negative transitions of the original signal.

The common output of IC1C 36 and IC1D 38 is connected to a positive trigger input on digital monostable pulse generator 40 via two summing diodes 42. The digital monostable pulse generator 40 is retriggerable and so as long as movement continues within a 30 second window the pulse output will remain HIGH.

This HIGH signal on pin 16 42 drives a relay RY1 coil 44. When the monostable output is TRUE (HIGH) the normally open contact NO 46 closes allowing current to flow through the lighting circuit described above. These illuminate the toilet bowl area as required.

When the user leaves the room the digital monostable pulse generator 40 times out and the relay contact goes back to its TRUE state (NO). The circuit is broken and so current ceases to flow and the lighting circuit is now OFF.

In some embodiments, the power is derived from a 9 Volt household battery located in a standard battery compartment adjacent to the circuit housing.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

For example, though white LEDs are described, lights of other colors may be used. Also, though a representative control circuit is described, it should be appreciated that a control circuit providing other functions may alternatively or additionally be used. For example, the night light assembly may include a pressure sensor or other suitable sensor to sense whether a toilet seat is down or up and the light circuit may control lights to provide a different visual appearance when the seat is down or up, such as to illuminate in different colored LEDs when the seat is down versus up.

As another example, a light sensor may be included to sense ambient light conditions without the lights 10 turned on. Such a senor may provide a further input to the control circuit, which may be configured so as not to turn on the lights when the ambient light is above a threshold level.

As yet a further example, though a motion detector is described, a component sensitive to IR or other radiation may be configured to sense the presence of an object within field of view 7, whether or not the object is moving. Also, though a passive sensor is described, it is not a requirement of the invention that the sensor be passive. A source of illumination may be included and directed into field of view 7. An object may be detected by sensing reflections of such radiation. Also, the type of radiation is not a limitation of the invention. For example, an ultrasonic motion or presence detector may alternatively or additionally be used.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A night light assembly for use with a toilet, the night light comprising:
a light attached to a support member configured for attachment to a toilet bowl;
a motion detector configured to sense a presence within a field of motion of the motion detector; and
a control circuit, coupled to the motion detector and the light, the control circuit being configured to illuminate the light in response to an output of the motion detector indicating motion within the field of view.

2. The night light assembly of claim 1, further comprising a support member configured for attachment to a toilet bowl.

3. The night light assembly of claim 2, wherein the motion detector is attached to the support member with the field of view facing in a first direction and the light is attached to emit light in a second direction, opposite the first.

4. The night light assembly of claim 1 further comprising a light sensor, wherein the light is deactivated when ambient light above a threshold level is sensed.

5. The night light assembly of claim 1, wherein the light is enclosed in flexible plastic tubing.

6. The night light assembly of claim 1 further comprising a pressure sensor to detect when a toilet seat is up or down.

7. The night light assembly of claim 6, wherein different colored LED's are illuminated when the toilet seat is down versus when the toilet seat is up.

8. A night light for use with a toilet, the night light comprising:
a motion detector configured to sense a presence within a field of motion of the motion detector;
a water resistant connector for attaching the night light to a toilet, wherein the water resistant connector is operatively attached to the motion detector;
flexible plastic tubing operatively attached to the water resistant connector; and
a light source enclosed in the flexible plastic tubing, wherein the light source is activated by the motion detector.

9. The night light of claim 8, wherein the motion detector is located on the front edge of a toilet bowl when in a mounted position.

10. The night light of claim 8, wherein the water resistant connector is a water resistant hinge.

11. The night light of claim 8, wherein the light source enclosed in the flexible plastic tubing is situated beneath the upper rim of a toilet bowl when in a mounted position.

12. The night light of claim 8, wherein the light source is at least one LED.

13. The night light of claim 8, wherein the light source is activated when the motion detector senses a presence within a field of motion of the motion detector.

14. The night light of claim 13, wherein the light source is deactivated within a set period of time and/or when the presence has moved from the field of detection.

15. The night light of claim 8, wherein the light source when activated by the motion detector, shines light upon the inside of a toilet bowl.

16. The night light of claim 8 further comprising a pressure sensor to detect when a toilet seat is up or down.

17. The night light of claim 16, wherein different colored LED's are illuminated when the toilet seat is down versus when the toilet seat is up.

18. The night light of claim 8 further comprising a light sensor, wherein the light is deactivated when ambient light above a threshold level is sensed.

19. A method for illuminating a toilet bowl comprising:
sensing a presence within a field of motion of a motion detector; and
directly illuminating a toilet bowl interior in response to the sensed presence.
